(19) United States
(12) Patent Application Publication
(10) Pub. No.: US 2026/0346874 A1
(43) Pub. Date: Nov. 5, 2026

(54) VEHICLE CAPABLE OF AUTONOMOUS DRIVING AND A METHOD OF CONTROLLING THE SAME

(71) Applicants: HYUNDAI MOTOR COMPANY, Seoul (KR); KIA CORPORATION, Seoul (KR)

(72) Inventor: Dong Hoon Kang, Hwaseong-si (KR)

(73) Assignees: HYUNDAI MOTOR COMPANY, Seoul (KR); KIA CORPORATION, Seoul (KR)

(21) Appl. No.: 19/394,586

(22) Filed: Nov. 19, 2025

(30) Foreign Application Priority Data
Apr. 30, 2025 (KR) 10-2025-0057428

(51) Int. Cl. B60W 60/00; B60W 50/00

(52) U.S. Cl. CPC B60W 60/0016; B60W 50/0097; B60W 2050/0026; B60W 2540/227; B60W 2554/4041; B60W 2554/801; B60W 2710/20; B60W 2754/20; B60W 2754/30

(57) ABSTRACT

The vehicle that allows autonomous driving includes: at least one processor; and at least one memory configured to store at least one program executed by the at least one processor, wherein the at least one processor is configured to control driving of the vehicle so that a collision occurs at a collision point at which side damage to the vehicle is reduced, based on a seating location of a passenger and an adjacent object present in predetermined distance from the vehicle in a first side collision in which a collision on a first side of the vehicle with a first vehicle is predicted and a side damage mitigation setting is active.

### CROSS-REFERENCE TO RELATED APPLICATION

This application claims priority to and the benefit of Korean Patent Application No. 10-2025-0057428 under 35 U.S.C. § 119, filed on Apr. 30, 2025, in the Korean Intellectual Property Office, the entire contents of which are incorporated herein by reference.

### FIELD

The present disclosure relates to a vehicle capable of autonomous driving and a method of controlling the same.

### BACKGROUND

The statements in this section merely provide background information related to the present disclosure and may not constitute prior art.

An existing driving safety system provides a proactive preemptive response to a front collision situation but only performs a post-collision response such as airbag deployment after a collision in a side collision situation. In a situation in which a side collision of a vehicle is predicted to occur and there are passengers on board, significant damage may occur, and vulnerable people (for example, children) seated in a second or third row of the vehicle are more vulnerable to damage from impact than general passengers.

In a side collision, the impact is likely to be transferred through a relatively weak part of the vehicle due to structural characteristics, and this may cause greater risk to passengers inside the vehicle. Therefore, even in a side collision situation, a technology capable of predicting a collision and preparing for the collision in advance is necessary, in addition to traditional countermeasures such as airbag deployment at the time of collision.

### SUMMARY

The various embodiments of the present disclosure provide a vehicle capable of autonomous driving and a method of controlling the same, which controls a vehicle so that damage to passengers seated at the side is reduced when a side collision is predicted.

According to an embodiment of the present disclosure, a vehicle that allows autonomous driving includes: at least one processor; and at least one memory configured to store at least one program executed by the at least one processor. In particular, the at least one processor is configured to control driving of the vehicle so that a collision occurs at a collision point at which side damage to the vehicle is reduced, based on a seating location of a passenger and an adjacent object present in predetermined distance from the vehicle in a first side collision in which a collision on a first side of the vehicle with a first vehicle is predicted and a side damage mitigation setting is active.

The at least one processor may include: a determination unit configured to determine a collision point at which passenger damage is minimized, based on at least one of the seating location of the passenger or the adjacent object when the first side collision with the first vehicle is predicted; and a control unit configured to perform lateral control or longitudinal control of the vehicle to prevent a collision with the adjacent object and to cause the collision with the first vehicle at the collision point based on that the adjacent object is present.

The adjacent object may include at least one of a preceding vehicle that drives in front of the vehicle, a following vehicle that drives behind the vehicle, or a side adjacent object that possibly collides with a second side of the vehicle.

The determination unit may be configured to transmit a preset safety margin distance to the control unit to prevent a collision between the side object and the vehicle when there is the adjacent object. The control unit may be configured to perform lateral control or longitudinal control of the vehicle based on the preset safety margin distance.

A preset safety margin distance when the passenger is seated on the second side of the vehicle may be equal to or greater than a preset safety margin distance when the passenger is not seated on the second side.

The determination unit may be configured to transmit, to the control unit, a preset safety margin distance for preventing a collision between the preceding vehicle and the vehicle when there is a preceding vehicle. The control unit is configured to perform lateral control or longitudinal control of the vehicle based on the preset safety margin distance.

The determination unit may be configured to compare an initially calculated prediction time point of the collision with the first vehicle with a preset reference value to select one of a plurality of collision points determined based on at least one of the seating location of the passenger or the adjacent object when there are the plurality of collision points.

The determination unit may be configured to select the collision point requiring less steering control among the plurality of collision points when the prediction time point of the collision with the first vehicle is within the preset reference value.

The determination unit may be configured to select the collision point requiring more steering control among the plurality of collision points when the prediction time point of the collision with the first vehicle is greater than the preset reference value.

The determination unit may be configured to transmit collision reference information including at least one of a location of the determined collision point, the presence or absence of a passenger, a seating location of the passenger, the presence or absence of a side object, the presence or absence of a preceding vehicle, a preset safety margin distance between the side object and the vehicle, or a preset safety margin distance between the preceding vehicle and the vehicle to the control unit. The control unit may be configured to perform lateral control or longitudinal control of the vehicle based on the collision reference information.

The at least one processor may be configured to perform at least one of lateral control or longitudinal control of the vehicle so that the damage to at least one of a vulnerable passenger or a general passenger is minimized based on whether a priority for the vulnerable passenger is set.

The determination unit may be configured to determine the collision point using a matching table in which one or more collision points are matched with each of a plurality of conditions. The plurality of conditions may include first condition in which there is no passenger, side object, or preceding vehicle, second condition in which there are a passenger and side object, and there is no preceding vehicle, third condition in which there is a passenger, and there is no side object or preceding vehicle, and fourth condition in which there are a passenger and a side object, there is no preceding vehicle, a priority for a vulnerable passenger in a side damage mitigation setting is active, and one or more vulnerable passengers are included among passengers. The plurality of conditions may further include fifth condition in which there is a passenger, there is no side object or preceding vehicle, a priority for a vulnerable passenger is set, and one or more vulnerable passengers are included among passengers and sixth, seventh, eighth, ninth, and tenth conditions in which the presence of a preceding vehicle is added to first, second, third, fourth, and fifth conditions, respectively.

According to another embodiment of the present disclosure, a method of controlling a vehicle that allows autonomous driving is provided. The vehicle includes at least one processor and at least one memory configured to store at least one program executed by the at least one processor. The method includes: predicting a first side collision, which occurs when a first vehicle collides with a first side of the vehicle; and controlling driving of the vehicle so that a collision occurs at a collision point at which side damage to the vehicle is minimized, based on a seating location of a passenger and an adjacent object present in predetermined distance from the vehicle in a case where a side damage mitigation setting is active.

The controlling of the driving of the vehicle may include determining a collision point at which passenger damage is minimized, based on at least one of the seating location of the passenger or the adjacent object when the a first side of the vehicle with the first vehicle is predicted; and performing lateral control or longitudinal control of the vehicle so that the collision with the first vehicle occurs at the collision point while preventing a collision with the adjacent object when there is an adjacent object.

The adjacent object may include a preceding vehicle that drives in front of the vehicle, a following vehicle that drives behind the vehicle, and a side object that possibly collides with a second side of the vehicle.

The determining of the collision point may include confirming a preset safety margin distance to prevent a collision between the side object and the vehicle when there is the side object, and the performing of the lateral control or longitudinal control may include performing lateral control or longitudinal control of the vehicle based on the safety margin distance.

A preset safety margin distance when the passenger is seated on the second side of the vehicle is equal to or greater than a preset safety margin distance when the passenger is not seated on the second side.

The determining of the collision point may include confirming a preset safety margin distance for preventing a collision between the preceding vehicle and the vehicle when there is a preceding vehicle, and the performing of the lateral control or longitudinal control may include performing lateral control or longitudinal control of the vehicle based on the preset safety margin distance.

The determining of the collision point may include comparing an initially calculated prediction time point of the collision with the first vehicle with a preset reference value to select one of a plurality of collision points determined based on at least one of the seating location of the passenger or the adjacent object when there are a plurality of collision points.

The determining of the collision point may include selecting the collision point requiring less steering control among the plurality of collision points when the prediction time point of the collision with the first vehicle is within the preset reference value.

The determining of the collision point may include selecting the collision point requiring more steering control among the plurality of collision points when the prediction time point of the collision with the first vehicle is greater than the preset reference value.

The determining of the collision point may include generating collision reference information including at least one of a location of the determined collision point, the presence or absence of a passenger, a seating location of the passenger, the presence or absence of a side object, the presence or absence of the preceding vehicle, a preset safety margin distance between the side object and the vehicle, or a preset safety margin distance between the preceding vehicle and the vehicle, and the performing of the lateral control or longitudinal control may include performing lateral control or longitudinal control of the vehicle based on the collision reference information.

The controlling of the driving may include performing at least one of lateral control or longitudinal control of the vehicle to minimize damage to at least one of a vulnerable passenger or a general passenger based on whether a priority for the vulnerable passenger is set.

Effects that can be obtained from the present disclosure are not limited to that described above, and other effects that have not been described will be clearly understood by those having ordinary skill in the technical field to which the present disclosure pertains from the following description.

### BRIEF DESCRIPTION OF THE DRAWINGS

The above and other objects, features and advantages of the present disclosure will become more apparent to those of having ordinary skill in the art by describing exemplary embodiments thereof in detail with reference to the accompanying drawings, in which:

FIG. 1 is a schematic block diagram illustrating a vehicle capable of autonomous driving according to an embodiment of the present disclosure;

FIG. 2 is a schematic diagram illustrating an example in which a side damage mitigation function and a priority for a vulnerable passenger are set by a driver;

FIG. 3 is a block schematic diagram illustrating a processor according to an embodiment of the present disclosure;

FIG. 4 is a schematic diagram illustrating an operation in which a determination unit determines whether a side collision has occurred;

FIG. 5 is a schematic diagram illustrating collision points set on the side and rear of a vehicle;

FIG. 6 is a schematic diagram illustrating collision points set for type 1 and vehicle control;

FIG. 7A is a schematic diagram illustrating collision points set for respective subtypes of type 2;

FIGS. 7B and 7C are schematic diagrams illustrating collision points set for the subtypes of type 2 and vehicle control;

FIG. 8A is a schematic diagram illustrating collision points set for respective subtypes of type 3;

FIGS. 8B, 8C, 8D, and 8E are schematic diagrams illustrating collision points set for the respective subtypes of type 3 and vehicle control;

FIG. 9 is a schematic diagram illustrating collision points set for respective subtypes of type 4;

FIG. 10 is a schematic diagram illustrating collision points set for respective subtypes of type 5;

FIGS. 11, 12, 13, and 14 illustrate schematic collision points of types 2, 3, 4, and 5 in a two-row vehicle;

FIG. 15 is a schematic flowchart illustrating a method of controlling a vehicle capable of autonomous driving according to an embodiment of the present disclosure;

FIG. 16 is a schematic flowchart illustrating operation S400 illustrated in FIG. 15 in detail; and

FIG. 17 is a schematic flowchart illustrating operation S400 illustrated in FIG. 15 in more detail.

### DETAILED DESCRIPTION

Hereinafter, exemplary embodiments of the present disclosure are described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements is omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an embodiment could be termed a second element in another embodiment, and, similarly, a second element in an embodiment could be termed a first element in another embodiment, without departing from the scope of the present disclosure.

The terms used herein to describe embodiments of the present disclosure is not intended to limit the scope of the present disclosure. The articles “a,” and “an” are singular in that they have a single referent, however the use of the singular form in the present document should not preclude the presence of more than one referent. In other words, elements of the present disclosure referred to in the singular may number one or more, unless the context clearly indicates otherwise. It will be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

In the present disclosure, elements that are distinguished from each other are for clearly describing each feature, and do not necessarily mean that the elements are separated. In particular, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

The advantages and features of the present disclosure and the way of attaining them will become apparent with reference to embodiments described below in detail in conjunction with the accompanying drawings. Embodiments, however, may be embodied in many different forms and should not be constructed as being limited to example embodiments set forth herein. Rather, these embodiments are provided so that this disclosure will be complete and will fully convey the scope of the invention to those skilled in the art.

In the present disclosure, each of phrases such as “A or B”, “at least one of A and B”, “at least one of A or B”, “A, B or C”, “at least one of A, B and C”, “ ” at Each of the phrases such as “at least one of A, B or C” and “at least one of A, B, C or combination thereof” may include any one or all possible combinations of the items listed together in the corresponding one of the phrases.

Hereinafter, one or more embodiments of the present disclosure are described with reference to the accompanying drawings.

Firstly, some of the terms used in the embodiments of the present disclosure will be defined.

A first side is either the right side or the left side of a vehicle 100 in its driving direction, and a second side is the side opposite to the first side. For example, when the first side is the right side of the vehicle 100, the second side is the left side.

A preceding vehicle is a vehicle that drives in front of the vehicle 100 in the driving direction of the vehicle 100.

A following vehicle is a vehicle that drives behind the vehicle 100 in the driving direction of the vehicle 100.

A first vehicle 10 is a side vehicle that drives on the right side in the driving direction of the vehicle 100.

A second vehicle 20 is a side vehicle that drives on the left side in the driving direction of the vehicle 100.

The first side may be the right side of the vehicle 100 in which a collision between the vehicle 100 and the first vehicle 10 is expected to occur.

The second side may be the left side of the vehicle 100 in which a collision between the vehicle 100 and the second vehicle 20 is expected to occur.

“Lateral control” means to control the driving direction of the vehicle 100 and may be used with the same meaning as “steering control.”

“Longitudinal control” means to control a driving speed of the vehicle 100 and may be used with the same meaning as “acceleration and deceleration control.”

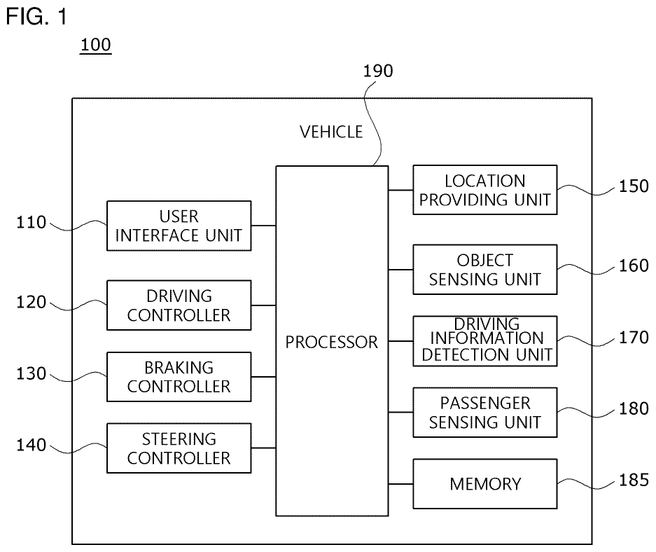

FIG. 1 is a block schematic diagram illustrating the vehicle 100 capable of autonomous driving according to an embodiment of the present disclosure.

The vehicle 100 illustrated in FIG. 1 may provide autonomous driving technology that enables the vehicle to drive itself without driver intervention. The autonomous driving may be designed to recognize a driving environment, plan a route, and avoid collisions with other objects including vehicles and pedestrians. To this end, the vehicle 100 may use a plurality of sensors, a GPS module, a high-performance computer, or an artificial intelligence technology. The plurality of sensors may include, for example, cameras, lidar, or radar.

Referring to FIG. 1, the vehicle 100 capable of autonomous driving according to an embodiment of the present disclosure may include a user interface unit 110, a driving controller 120, a braking controller 130, a steering controller 140, a location providing unit 150, an object sensing unit 160, a driving information detection unit 170, a passenger sensing unit 180, a memory 185, and the processor 190. Further, the vehicle 100 may include an autonomous driving controller for autonomous driving, and the autonomous driving controller may include the driving controller 120, the braking controller 130, the steering controller 140, the memory 185, and the processor 190, or may include the memory 185 and the processor 190.

The user interface unit 110 may receive commands for operating various functions that can be performed in the vehicle from a driver and transfers the commands to the processor 190, and display results of performing functions in the vehicle 100 or information input by the driver. The commands for operating various functions include, for example, commands for setting a user select mode (USM), turning an autonomous driving mode on and off, setting a side damage mitigation function, setting a priority for a vulnerable passenger, setting the vulnerable passenger, selecting a seat in which the vulnerable passenger is seated, and inputting a destination in a navigation system.

For example, the driver may set the vulnerable passenger by designating a seat in which the vulnerable passenger is seated through a seat screen displayed on the user interface unit 110. Alternatively, a camera (not shown) installed inside the vehicle 100 may automatically analyze a face and body shape of the vulnerable passenger and classify the vulnerable passenger, and the processor 190 to be described below may set the vulnerable passenger classified by the camera.

For example, the side damage mitigation function may be a control logic configured to mitigate side damage of the vehicle 100. Also, “the side damage mitigation feature is set” may also mean that the side damage mitigation setting is active.

For example, The side damage mitigation function may be a function of controlling steering or a speed of the vehicle 100 so that a collision occurs at a point at which the damage to passengers seated on the right side of the vehicle 100 is minimized when a collision between the vehicle 100 and the first vehicle 10 is predicted to occur on a first side of the vehicle 100. The side damage mitigation function further includes determining whether to apply a priority for the vulnerable passenger. The priority for the vulnerable passenger is a mode in which the safety of the vulnerable passengers is prioritized.

For example, when the vehicle 100 is shipped from the factory, the side damage mitigation function may be set to be activated (or applied) by default, and the priority for the vulnerable passenger may be set not to be applied by default. The driver may change whether to apply the side damage mitigation function and whether to apply the priority for the vulnerable passenger. When the driver changes the setting of the side damage mitigation function through the USM setting, a changed value may be stored in the memory 185.

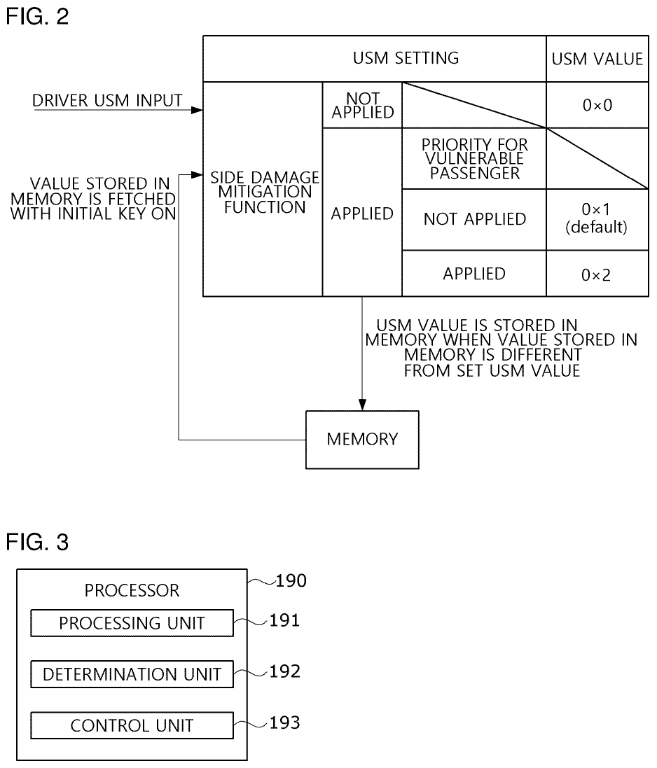

FIG. 2 is a schematic diagram illustrating an example in which the side damage mitigation function and the priority for the vulnerable passengers are set by the driver.

Referring to FIG. 2, the application of the side damage mitigation function and the non-application of the priority for the vulnerable passengers are stored in the memory 185 by default (0x1). The user may select whether or not to apply the side damage mitigation function through the USM setting. When the non-application is selected, 0x0 may be stored as a USM value in the memory 185.

Further, when the user selects the application of the side damage mitigation function and the non-application of the priority for the vulnerable passengers, 0x1 may be stored as the USM value in the memory 185.

Further, when the user selects the application of the side damage mitigation function and the application of the priority for the vulnerable passengers, 0x2 may be stored as the USM value in the memory 185.

When the driver turns the vehicle 100 on (KEY ON), the processor 190 to be described below loads the USM value stored in the nonvolatile memory 185, and when the stored USM value is 0x0 (or the side damage mitigation function is not activated), the processor 190 may change the USM value to an initial default to ensure the safety of the passengers. This may cause the side damage mitigation function to be activated upon restarting, and it is possible to induce the driver to activate the side damage mitigation function again each time the driver deactivates the side damage mitigation function.

Further, when the loaded USM value is 0x1 or 0x2, this may be determined to be a last value at the time of KEY OFF, and the USM value may be maintained as it is so that the function is performed.

Referring back to FIG. 1, the driving controller 120 may control a driving system to control the driving speed of the vehicle 100. The driving controller 120 may receive a required acceleration calculated by the processor 190 and convert the required acceleration into a control signal (for example, torque) for controlling the driving system. When the vehicle 100 is an internal combustion engine vehicle, the driving system may include an engine, and the driving controller 120 may be an engine management system (EMS) that controls main operations (driving, acceleration, deceleration) of an engine. When the vehicle 100 is an electric vehicle, the driving system may include a driving motor and a battery, and the driving controller 120 may be a vehicle control unit (VCU).

The braking controller 130 may decelerate or stop the vehicle 100 through friction with the wheels. The braking controller 130 may be, for example, an integrated electric brake (IEB).

The steering controller 140 may control the steering system to control the driving direction of the vehicle 100. The steering controller 140 may receive the steering angle or steering angular velocity calculated by the processor 190 and convert the steering angle or steering angular velocity into a control signal (for example, torque) for controlling the steering system. The steering system may change the driving direction of the vehicle 100 in response to a control signal according to a manual operation of the driver through the steering wheel or autonomous driving. The steering controller 140 may be, for example, motor driven power steering (MDPS).

The location providing unit 150 may include a Global Positioning System (GPS) module that provides current location information of the vehicle 100. For example, the GPS module may communicate with one or more GPS satellites to calculate the location of the vehicle 100.

The object sensing unit 160 may periodically or continuously acquire sensing information necessary for autonomous driving and transmit the sensing information to the processor 190. The object sensing unit 160 may include one or more cameras, one or more LiDARs, and one or more radars. The object sensing unit 160 may detect an object and acquire sensing information including a distance between the detected object and the vehicle 100, a speed or relative speed, a size or location, and heading information of the object, and the presence or absence of the object.

The object may include the first vehicle 10 and an adjacent object, and the adjacent object may be an object that drives or is located near the vehicle 100, and may include a preceding vehicle, a following vehicle, and a side object. The side object may be an object that collides with the second side of the vehicle 100 and may include all unspecified objects located on the left side of the vehicle 100, such as the second vehicle, a guardrail, a wall, and a person. The adjacent object may be used for control so that a pre-collision with the adjacent object due to a behavior for side damage mitigation is not caused.

For example, one or more cameras may photograph the surroundings of the vehicle 100 configured to acquire continuous images, detect the adjacent object from the acquired continuous images, and acquire sensing information related to the adjacent object.

For example, one or more lidars may detect the adjacent object of the vehicle 100 using laser light and acquire sensing information related to the adjacent object.

For example, one or more radars may detect the adjacent object of the vehicle 100 using electromagnetic waves and acquire sensing information related to the adjacent object.

The driving information detection unit 170 may acquire driving information of the vehicle 100 and transmit the driving information to the processor 190. The driving information may be acquired by one or more wheel speed sensors, one or more acceleration sensors, and one or more steering sensors, and may include driving speed, driving acceleration, driving direction (or steering), front wheel angle, and the like of the vehicle 100. For example, the wheel speed sensor may be installed on a wheel of the vehicle 100 to detect a driving speed, and the steering sensor may detect a steering angle from an angle of a steering wheel.

The sensing information and the driving information may be used for control of the autonomous driving of the vehicle 100.

The passenger sensing unit 180 may detect a seat location of a passenger on board the vehicle 100 and transfer the detected seat location of the passenger to the processor 190. The passenger on board the vehicle 100 may be roughly classified as a driver or a passenger, and the passenger may be classified as a vulnerable passenger or a general passenger (or non-vulnerable passenger).

The memory 185 may store at least one program (for example, an operating system, software, firmware, middleware, or an application), various types of data, and at least one command for operation or control of the vehicle 100 and may load the program or read or write the data in response to a request from the processor 190. The memory 185 may include a volatile memory and a nonvolatile memory.

Further, the memory 185 may include at least one of storage media such as a random access memory (RAM), a static random access memory (SRAM), a read only memory (ROM), a programmable read only memory (PROM), an electrically erasable and programmable ROM (EEPROM), an erasable and programmable ROM (EPROM), a hard disk drive (HDD), a solid state disk (SSD), an embedded multimedia card (eMMC), a universal flash storage (UFS), and/or a web storage.

As an example, the program stored in the memory 185 may include at least one program (or instruction) configured to predict a side collision from sensing information and host vehicle information and determine a collision point at which damage to passengers because the collision is minimized.

Further, the memory 185 may store the default value of the side damage mitigation function described with reference to FIG. 2 and the USM setting value changed by the driver.

Further, the memory 185 may store the first, second, and third matching tables.

The first matching table may be a table in which a preset safety margin distance that the vehicle 100 is to maintain from the side object present on the second side of the vehicle 100 is matched with a location of a passenger in the vehicle 100 when the first vehicle 10 is driving on the first side of the vehicle 100 and a collision with the first vehicle 10 is predicted on the first side. The preset safety margin distance may be a minimum distance that has to be maintained to prevent the collision between the vehicle 100 and the side object present on the second side opposite to the first side. In other words, in the first matching table, the preset safety margin distance may be matched depending on whether the passenger is on the first side or on the second side.

For example, the preset safety margin distance between the side object and the vehicle 100, when there is no passenger on the second side (hereinafter referred to as a “first preset safety margin distance”) and the preset safety margin distance between the side object and the vehicle 100, when there is a passenger on the second side (hereinafter referred to as a “second preset safety margin distance”) may be matched and stored in the first matching table. The second preset safety margin distance may be equal to or greater than the first preset safety margin distance. The first and second preset safety margin distances may be changed, and the second preset safety margin distance may be generally set within a lane, and steering control may be performed so that the vehicle is maintained as close to a lane line as possible upon biasing.

The second matching table may be a table in which a preset safety margin distance that the vehicle 100 is to maintain from the side object present on the first side of the vehicle 100 is matched with a location of a passenger in the vehicle 100 when the second vehicle 20 is driving on the second side (for example, the left side) of the vehicle 100 and a collision with the second vehicle 20 is predicted on the second side.

The third matching table may be a table in which collision points at which damage to passengers due to collision is minimized are matched with a plurality of types (or conditions) when a side collision is predicted. The plurality of types (or conditions) may be distinguished based on a seating location of a passenger, the presence or absence of a vulnerable passenger, and the presence or absence of an adjacent object. One or more collision points may be matched with one type (or condition), or the plurality of collision points may be matched with one type. Therefore, one or more collision points may be matched in advance based on the presence or absence of a passenger, seating location, the presence or absence of a vulnerable passenger, and the presence or absence of an adjacent object.

Table 1 shows a plurality of types (or conditions)

TABLE 1

| | | | Setting of priority of | |
|---|---|---|---|---|
| | | | vulnerable passenger | |
| | | | and | |
| | Presence/absence | Presence/absence | presence/absence of | Presence/absence of |
| Type | of passenger | of side object | vulnerable passenger | preceding vehicle |
| Type 1 (First | X | X | X | X |
| condition) | | | | |
| Type 2 (Second | ◯ | ◯ | X | X |
| condition) | | | | |
| Type 3 (Third | ◯ | X | X | X |
| condition) | | | | |
| Type 4 (Fourth | ◯ | ◯ | ◯ | X |
| condition) | | | | |
| Type 5 (Fifth | ◯ | X | ◯ | X |
| condition) | | | | |
| Type 6 (Sixth | X | X | X | ◯ |
| condition) | | | | |
| Type 7 (Seventh | ◯ | ◯ | X | ◯ |
| condition) | | | | |
| Type 8 (Eight | ◯ | X | X | ◯ |
| condition) | | | | |
| Type 9 (Ninth | ◯ | ◯ | ◯ | ◯ |
| condition) | | | | |
| Type 10 (Tenth | ◯ | X | ◯ | ◯ |
| condition) | | | | |

In Table 1, “O” may denote presence, and “X” may denote absence. The plurality of types may be classified into Types 1, 2, 3, 4, 5, 6, 7, 8, 9, and 10 (or first, second, third, fourth, fifth, sixth, seventh, eighth, ninth, and tenth conditions).

Type 1 (First condition) may be a type (or condition) without passengers, side objects, or preceding vehicles.

Type 2 (Second condition) may be a type (or condition) in which passengers and side objects exist, but there is no preceding vehicle, and is classified into a plurality of subtypes depending on locations of the passengers.

Type 3 (Third condition) may be a type (or condition) in which there are passengers, but there is no side object or preceding vehicle, and is classified into a plurality of subtypes depending on locations of the passengers.

Type 4 (Fourth condition) may be a type (or condition) in which there are a passenger and a side object, there is no preceding vehicle, the priority for the vulnerable passenger is set in the side damage mitigation functions, and one or more vulnerable passengers are included among passengers. Type 4 (Fourth condition) is divided into a plurality of subtypes depending on locations of the passengers.

Type 5 (Fifth condition) may be a type (or condition) in which there is a passenger, there is no preceding vehicle and a side object, a priority for a vulnerable passenger is set, and one or more vulnerable passengers are included among passengers. Type 5 (Fifth condition) may be divided into a plurality of subtypes depending on locations of the passengers.

Types 6, 7, 8, 9, and 10 (or first, second, third, fourth, fifth, sixth, seventh, eighth, ninth, and tenth conditions) are types (or conditions) in which there is a preceding vehicle in types 1, 2, 3, 4, and 5 (or first, second, third, fourth, and fifth conditions), respectively. The collision points matching types 1, 2, 3, 4, 5, 6, 7, 8, 9, and 10 or (first, second, third, fourth, fifth, sixth, seventh, eighth, ninth, and tenth conditions) may vary depending on a seating location of the passenger or a seating location of the vulnerable passenger.

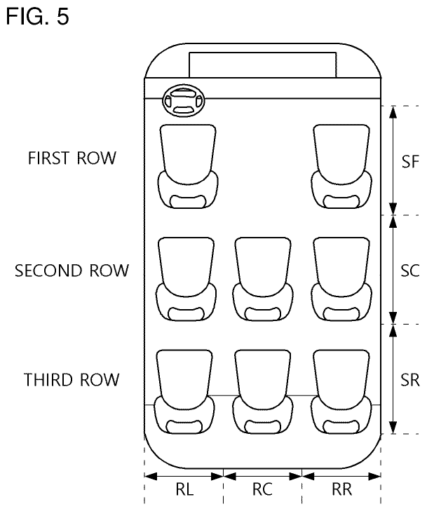

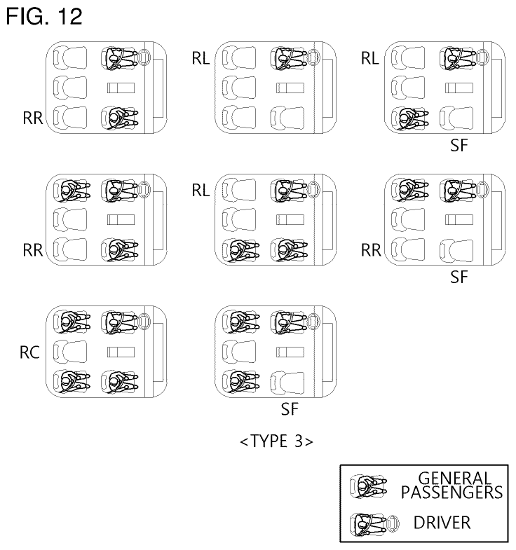

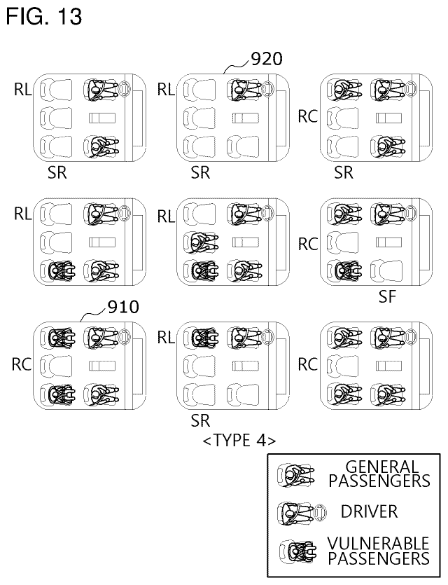

The collision points matched with the plurality of types and a vehicle control operation according to the collision points are described below with reference to FIGS. 5, 6, 7A, 7B, 7C, 8A, 8B, 8C, 8D, 8E, 9, 10, 11, 12, 13, and to 14.

Further, the memory 185 may store a third preset safety margin distance that the vehicle 100 and a preceding vehicle are to maintain and a fourth preset safety margin distance that the vehicle 100 and a following vehicle are to maintain.

The processor 190 may perform overall control of the vehicle 100 according to an input command or signal. The command or signal may be input to the processor 190 by the memory 185 or a communication module (not shown). The processor 190 may execute the program or command stored in the memory 185 to control an operation of other components (hardware or software) and perform data processing and computation. Further, the processor 190 may load a command or data received from another component into a volatile memory, process the command or data stored in the volatile memory, and store processing results in a nonvolatile memory.

The processor 190 may include, for example, at least one of processing devices such as a central processing unit (CPU), a digital signal processor (DSP), an application specific integrated circuit (ASIC), a programmable logic device (PLD), a field programmable gate array (FPGA), an application specific integrated circuit (ASIC), a microcontroller, and/or a microprocessor.

When a collision with the first vehicle 10 on the first side of the vehicle 100 (hereinafter referred to as a “first side collision”) is predicted and the side damage mitigation function is set to be activated, the processor 190 may control the driving of the vehicle 100 so that the collision occurs at a collision point at which side damage of the vehicle 100 is minimized, based on at least one of the seating location of the passenger and/or the adjacent object. The side damage of the vehicle 100 may be damage that may occur to a passenger when the passenger is seated in a seat corresponding to the first side.

The first side may be the right side of the vehicle 100, and the second side may be the left side opposite to the first side. Alternatively, the first side may be the left side of the vehicle 100, and the second side may be the right side opposite to the first side. Hereinafter, a case in which the first side is the right side is described as an example, and since an operation when the first side is the left side is opposite to an operation when the first side is the right side, detailed description thereof is omitted.

FIG. 3 is a block schematic diagram illustrating the processor 190 according to an embodiment of the present disclosure.

Referring to FIG. 3, the processor 190 may include a processing unit 191, a determination unit 192, and a control unit 193. The components 191, 192, and to 193 represent functionally distinct elements and may be implemented by two or more elements being physically integrated or may be implemented in a form in which each element is physically distinct. Further, at least one of the components 191, 192, and 193 may be implemented in the form of a command stored in the memory 185.

The processing unit 191 may process or convert object sensing information input from the object sensing unit 160, driving information of the host vehicle 100 input from the driving information detection unit 170, and passenger location information input from the passenger sensing unit 180 into a form that can be recognized by the determination unit 192.

The determination unit 192 may periodically or continuously predict whether the first side collision between the first vehicle 10 and the vehicle 100 will occur based on the object sensing information and the driving information input from the processing unit 191. The determination unit 192 may predict whether the first side collision with the first vehicle 10 will occur based on at least one of a distance and/or relative speed with respect to the first vehicle 10, a size and location of the first vehicle 10, and a steering direction (or steering angle), speed, acceleration, and heading information of the vehicle 100.

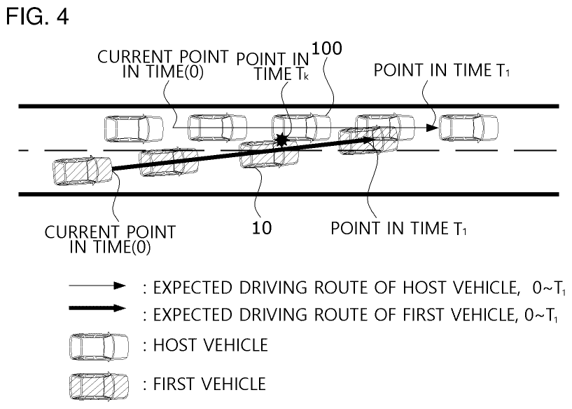

FIG. 4 is a schematic diagram illustrating an operation in which the determination unit 192 determines whether a side collision has occurred.

Referring to FIG. 4, the vehicle 100, which is the host vehicle, may drive in a first lane, and the first vehicle 10 may drive in a second lane. T₁ may be a reference time (or threshold time) configured to determine that a side collision between the first vehicle 10 and the vehicle 100 will occur, may be set to, for example, 2 seconds, and may be changed. Tₖ may be an arbitrary point in time between 0 seconds and T₁, and when a current point in time is set to 0, Tₖ may be a point in time at which a collision is predicted to occur (hereinafter referred to as a “collision prediction time point”). An initially calculated collision prediction time point may be changed in real time as the vehicle 100 and the first vehicle 10 continue to drive.

The determination unit 192 may calculate a first driving prediction route from the current point in time 0 to T₁ using the speed, acceleration, and heading information of the vehicle 100 detected by the driving information detection unit 170. Furthermore, the determination unit 192 may calculate a second driving prediction route of the first vehicle 10 from the current point in time 0 to T₁. The determination unit 192 may compare the first driving prediction route with the second driving prediction route and predict that the first side collision will occur when the first side of the vehicle 100 and the first vehicle 10 intersect at the point in time Tₖ with reference to the current point in time 0. The first side may be a region from a front bumper to a rear bumper of the vehicle 100 with reference to a side direction in which the collision will occur.

When the determination unit 192 predicts that the first side collision will occur, the determination unit 192 may determine a collision point at which damage to passengers due to the collision is minimized. The determination unit 192 may determine a collision type based on a combination of at least two of the presence or absence and seating location of passenger, the presence or absence and seating location of a vulnerable passenger, the presence or absence and seating location of a preceding vehicle, and the presence or absence of a side object, and confirm the collision point matched with the determined collision type from the third matching table. In particular, the determination unit 192 may determine the collision point using the third matching table in which one or more collision points are matched with each of the plurality of types (or depending on the seating location of the passenger and the presence or absence of an adjacent object).

The collision point may include at least one of a part of the first side and/or a part of the rear of the vehicle 100 and may be stored for each of a plurality of types in the third matching table in advance. The rear of the vehicle 100 is a surface in which a tailgate (not shown) for opening and closing a trunk is located.

When the first side collision is predicted, the determination unit 192 may confirm whether there is a passenger in the vehicle 100, and when a passenger is present, the determination unit 192 may confirm whether there is a vulnerable passenger. For example, the determination unit 192 may confirm the presence or absence and a seating location of a general passenger or a vulnerable passenger from a video captured by an interior camera.

Further, when the first side collision is predicted, the determination unit 192 may confirm whether a side object is detected. When a side object is detected, the determination unit 192 may confirm whether a passenger is on the second side based on passenger location information. When there is no passenger on the second side, the determination unit 192 may confirm the first preset safety margin distance in the memory 185 and generate first side object information. The first side object information may include the confirmed first preset safety margin distance, a current distance between the side object and the vehicle 100 (hereinafter referred to as a “first current distance”), a first ratio between the first preset safety margin distance and the first current distance, and a relative speed, location, and size of the side object.

Further, the determination unit 192 may confirm the second preset safety margin distance in the memory 185 and generate second side object information when the first side collision is predicted, the side object is detected, and the passenger is on the second side. The second side object information may include the confirmed second preset safety margin distance, a current distance between the side object and the vehicle 100 (hereinafter referred to as a “second current distance”), a second ratio between the second preset safety margin distance and the second current distance, and a relative speed, location, and size of the side object.

Further, when the first side collision is predicted, the determination unit 192 may confirm whether a preceding vehicle is detected. When a preceding vehicle is detected, the determination unit 192 may confirm the third preset safety margin distance in the memory 185 and generate preceding vehicle information. The preceding vehicle information may include the confirmed third preset safety margin distance, a current distance between the preceding vehicle and the vehicle 100 (hereinafter referred to as a “third current distance”), a third ratio between the third preset safety margin distance and the third current distance, and a relative speed, location, and size of the preceding vehicle.

Further, when the first side collision is predicted, the determination unit 192 may confirm whether a following vehicle is detected. When a following vehicle is detected, the determination unit 192 may confirm the fourth preset safety margin distance in the memory 185 to generate following vehicle information. The following vehicle information may include the confirmed fourth preset safety margin distance, a current distance between the following vehicle and the vehicle 100 (hereinafter referred to as a “fourth current distance”), and a relative speed, location, and size of the following vehicle.

Further, when there are a plurality of collision points determined based on at least one of a seating location of the passenger and/or an adjacent object, the determination unit 192 may compare an initially calculated prediction time Tₖ of collision with the first vehicle 10 with a preset reference value to select one of the plurality of collision points as an actual collision point. For example, when the prediction time Tₖ of collision with the first vehicle 10 is within the preset reference value, the determination unit 192 may select a collision point requiring less steering control among the plurality of collision points since it is urgent to control the steering of the vehicle 100 within the collision prediction time Tₖ. In other words, the determination unit 192 may select a collision point closer to the first vehicle 10.

When a collision point is determined, the determination unit 192 may generate collision reference information and transfer the collision reference information to the control unit 193. The collision reference information may include at least one of a distance and/or relative speed from the first vehicle 10, a size and location of the first vehicle 10, a steering direction, speed, acceleration, and heading information of the first vehicle 10, a location of the determined collision point, the presence or absence of a passenger, a seating location of the passenger, the presence or absence of a side object, the presence or absence of a preceding vehicle, first side object information, second side object information, preceding vehicle information, and/or following vehicle information.

The control unit 193 may perform lateral control or longitudinal control of the vehicle 100 so that a collision with the first vehicle 10 occurs at the collision point determined by the determination unit 192.

Particularly, the control unit 193 may receive the collision reference information from the determination unit 192.

When there is no adjacent object, the control unit 193 may perform the lateral control or longitudinal control of the vehicle 100 so that a collision with the first vehicle 10 occurs at the collision point based on the received collision reference information.

Further, when there is an adjacent object, the control unit 193 may perform the lateral control or longitudinal control of the vehicle 100 so that a collision with the first vehicle 10 occurs at the collision point while preventing a pre-collision between the adjacent object and the vehicle 100 based on the collision reference information. For example, when there is a second vehicle as a side object, the control unit 193 may calculate a lateral control value (steering angle and steering angular velocity) using information (for example, a ratio) obtained by comparing a distance between the vehicle 100 and the second vehicle with the first preset safety margin distance. For example, a longitudinal control value may also be calculated.

As another example, when a preceding vehicle exists as a side object, the control unit 193 may calculate a longitudinal control value (acceleration and deceleration value, in particular, required acceleration) using information (for example, a ratio) obtained by comparing a distance between the vehicle 100 and the preceding vehicle with the third preset safety margin distance. For example, the lateral control value may also be calculated.

Further, the control unit 193 may perform at least one of the lateral control and/or the longitudinal control of the vehicle 100 so that damage to at least one of the vulnerable passenger and/or the general passenger is minimized based on whether or not the priority for the vulnerable passenger is set. For example, the control unit 193 may perform the lateral control and the longitudinal control in parallel or perform the longitudinal control to minimize collision damage to the vulnerable passenger when the priority for the vulnerable passenger in the side damage mitigation function is set and one or more vulnerable passengers are included among passengers.

Further, the control unit 193 may calculate the lateral control values and the longitudinal control values to perform vehicle control (driving system or braking system control) when the driving controller 120, the braking controller 130, and the steering controller 140 are integrated and implemented in the control unit 193.

Alternatively, the control unit 193 may calculate the lateral control values (for example, steering angle and steering angular velocity) for controlling the steering direction and then transfer the calculated lateral control values to the steering controller 140 so that the lateral control is performed. Further, the control unit 193 may calculate the longitudinal control values (for example, the required acceleration) for controlling the driving speed, and then output the calculated longitudinal control value to the driving controller 120 or the braking controller 130 so that the longitudinal control is performed. The steering controller 140 may control the steering system based on the received lateral control value, and the driving controller 120 or the braking controller 130 may control the driving system or the braking system based on the longitudinal control value.

Hereinafter, an operation in which the processor 190 determines a collision point for each of a plurality of types and controls driving is described with reference to FIGS. 5, 6, 7A, 7B, 7C, 8A, 8B, 8C, 8D, 8E, 9, 10, 11, 12, 13, and to 14.

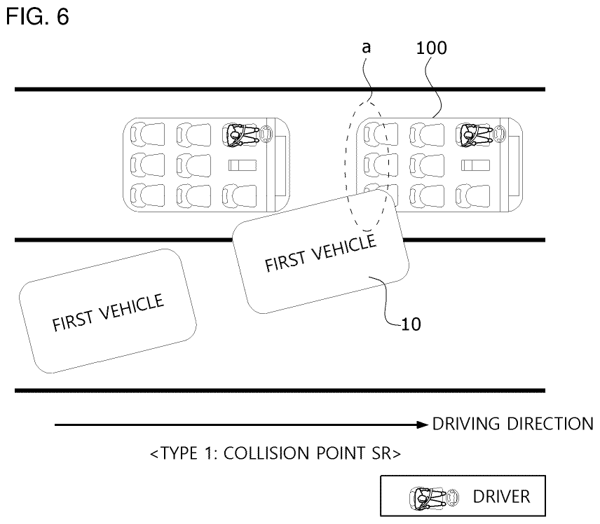

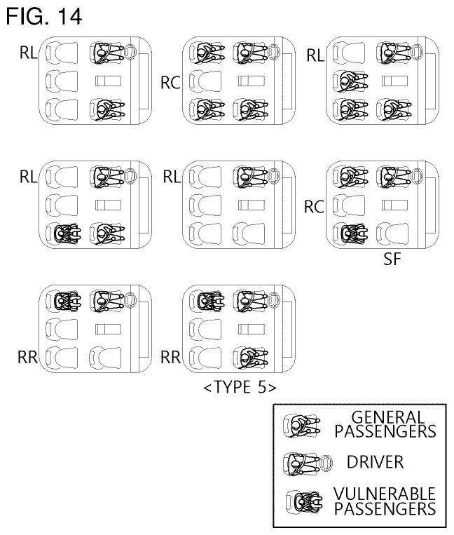

FIGS. 5, 6, 7A, 7B, 7C, 8A, 8B, 8C, 8D, 8E, 9, 10, 11, 12, 13, and 14 are diagrams illustrating an example in which a right side collision is predicted, and the sample may be applied in reverse in a case in which a left side collision is predicted. FIGS. 6, 7A, 7B, 7C, 8A, 8B, 8C, 8D, 8E, 9, 10 may illustrate types 1, 2, 3, 4, and 5 of collision points in a three-row vehicle, and different collision points may be matched depending on the seating location of the passenger.

FIG. 5 is a schematic diagram illustrating collision points set on the side and rear of the vehicle 100.

Referring to FIG. 5, the first side of the vehicle 100 may be divided into a collision point SF (or first collision point) corresponding to a front part of the first side, a collision point SC (or second collision point) corresponding to a central part, and a collision point SR (or third collision point) corresponding to a rear part. Further, the rear of the vehicle 100 may be divided into a collision point RR (or right collision point) corresponding to a right side of the rear side, a collision point RC (or center collision point) corresponding to a central part, and a collision point RL (or left collision point) corresponding to the left side.

FIG. 6 is a schematic diagram illustrating collision points set for type 1 and vehicle control.

Referring to FIG. 6, the vehicle 100 may be driving in a left lane, and the first vehicle 10 may be driving in a right lane on a first side of the vehicle 100. The collision point SR may be a collision point set to minimize damage due to collision in the case of type 1.

When the first vehicle 10 is predicted to collide with the first side of the vehicle 100, the determination unit 192 may determine that the collision type is type 1 since there are no passengers, side objects, or preceding vehicles. The determination unit 192 may confirm the collision point matched with type 1 from the third matching table. In the case of FIG. 6, since the driver is on board, the collision point SR that is farthest from the driver may be matched as the collision point of type 1. Therefore, the determination unit 192 may determine that the collision point SR is the collision point. For example, the determination unit 192 may include the collision point SR as much as possible, but when it is difficult to induce a collision at the collision point SR, the determination unit 192 may add a collision point a so that the collision occurs at the rear rather than the first side, and transfer the collision point a to the control unit 193.

The control unit 193 may calculate a maximum acceleration that can be calculated in a system boundary of the vehicle 100 since there are no passengers, side objects, or preceding vehicles, and perform vehicle control so that the vehicle is maximally likely to collide with the first vehicle 10 at the collision point SR. Accordingly, control for reducing damage to passengers due to collision may be performed. When the required acceleration set for the vehicle 100 is in a range of −a to b (a and b are positive numbers), b may be a maximum acceleration.

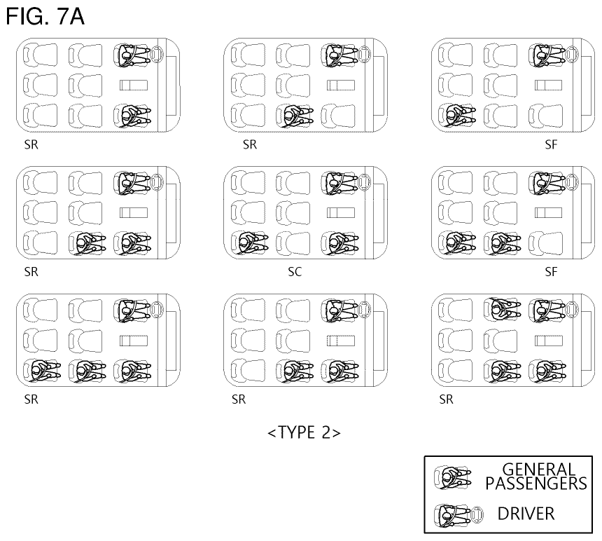

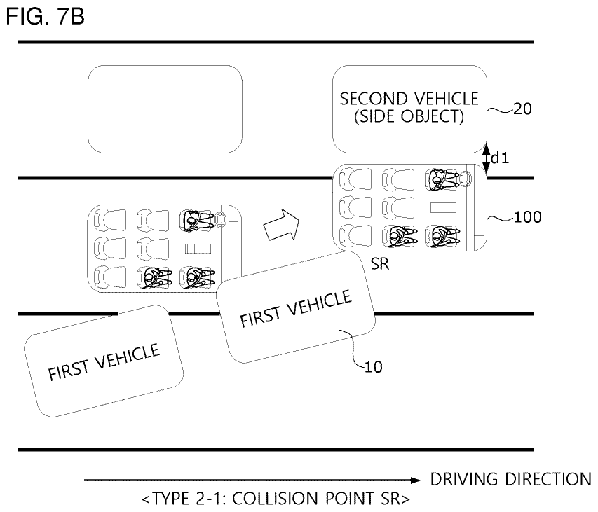

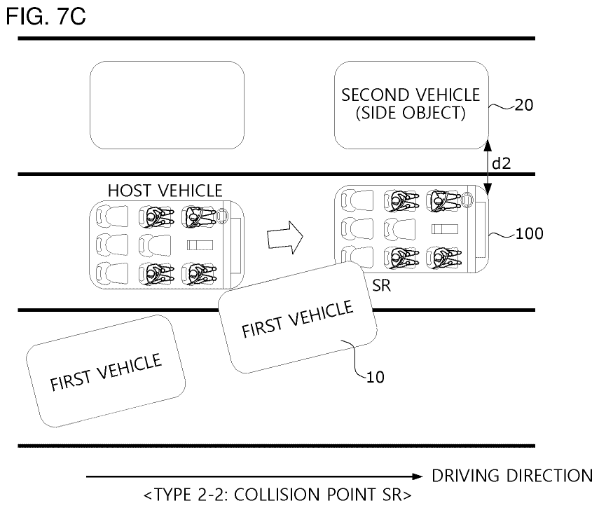

FIG. 7A is a schematic diagram illustrating collision points set for subtypes of type 2.

In FIG. 7A, some among all the subtypes of type 2 are illustrated. Referring to FIG. 7A, type 2 may be a type in which there are passengers and side objects, but there is no preceding vehicle, and most collision points matched with passenger locations of type 2 may be located on the first side. This may be intended to prevent collision with the side objects since there are side objects.

For example, when a passenger is seated in a passenger seat, the collision point SR may be matched in the third matching table. This may be because the point is determined to be an optimal location to minimize damage to the passenger in the passenger seat while preventing a collision with the side object.

As another example, when passengers are seated in the passenger seat and seats on the right side in a second row and the right side in a third row, the collision point SR may be matched in the third matching table. For example, the collision point RR may be a more suitable collision point than the collision point SR, but when the steering of the vehicle 100 is controlled to induce a collision at the collision point RR, a pre-collision with the side object may occur, and therefore, the collision point SR may be matched to prevent this.

In the case of type 2, the collision point may be determined according to seating locations of passengers, and acceleration and deceleration control may be performed to converge at the collision point. Since there is no preceding vehicle during acceleration and deceleration, the control unit 193 may calculate up to a maximum acceleration to control the vehicle.

FIGS. 7B and 7C are schematic diagrams illustrating collision points and vehicle control set for the subtypes of type 2.

Referring to FIG. 7B, the vehicle 100 may be driving in a center lane, the first vehicle 10 may be driving in a right lane on the first side of the vehicle 100, and a second vehicle 20, which is a side object, may be driving in the left lane.

When the determination unit 192 predicts that the first vehicle 10 will collide with the first side of the vehicle 100, the determination unit 192 may determine that the collision type is type 2 since there are passengers and side objects, but there is no preceding vehicle. The determination unit 192 may confirm seating locations of the passengers and determines the collision type is type 2-1 since the confirmed passenger locations are a passenger seat and a seat on the right side of a second row. The determination unit 192 may confirm the collision point SR matched with type 2-1 from the third matching table.

The control unit 193 may perform bias control based on the seating locations of the passengers and a first preset safety margin distance d1 from the second vehicle 20 since the passengers are located on the first side and the second vehicle 20 is there. Since there is no passenger on the second side opposite to an expected collision surface (the first side), the control unit 193 may perform steering control so that the vehicle 10 is biased by the first preset safety margin distance d1 at which the vehicle 100 does not collide with the second vehicle 20, and at the same time, may perform acceleration and deceleration control so that a collision occurs at the collision point SR.

Referring to FIG. 7C, when the determination unit 192 predicts that the first vehicle 10 will collide with the first side of the vehicle 100, the determination unit 192 may determine that the collision type is type 2 since there are passengers and a side object, but there is no preceding vehicle. The determination unit 192 may determine the collision type is type 2-2 since the confirmed locations of the passengers are the passenger seat and seats on the right and left sides in the second row. The determination unit 192 may confirm the collision point SR matched with type 2-2 from the third matching table.

The control unit 193 may perform bias control based on the seating locations of the passengers and a second preset safety margin distance d2 from the second vehicle 20 since the passengers are located on the first side and the second side and the second vehicle 20 is there. Since the passenger is on the second side opposite to the first side, the control unit 193 may perform steering control so that the vehicle 100 is biased by the second preset safety margin distance d2 at which the vehicle 100 does not collide with the second vehicle 20, and at the same time, may perform acceleration and deceleration control so that a collision occurs at the collision point SR.

Referring to FIGS. 7B and 7C, the first preset safety margin distance d1 is shorter than the second preset safety margin distance d2. This is for the purpose of performing the bias control so that the vehicle 100 approaches the second vehicle 20 since there is no passenger on the second side of the vehicle 100.

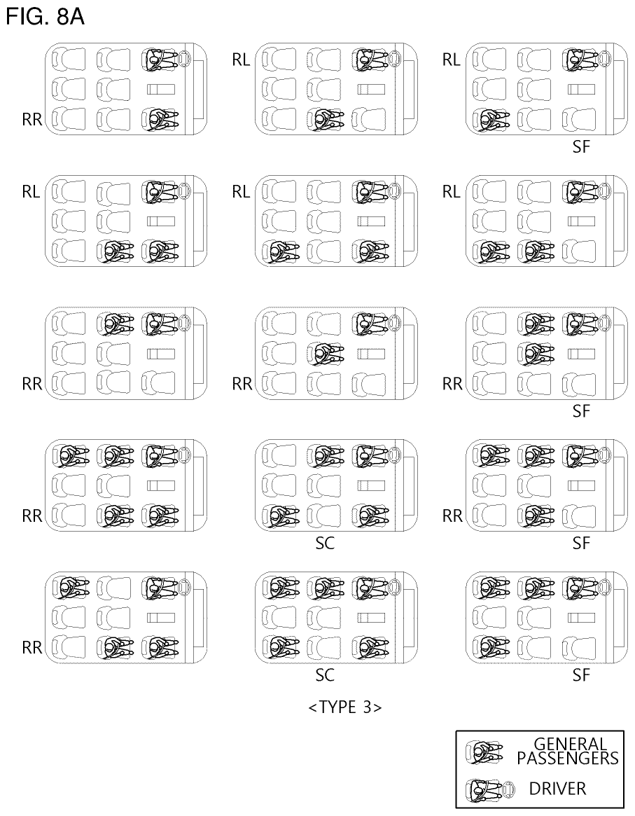

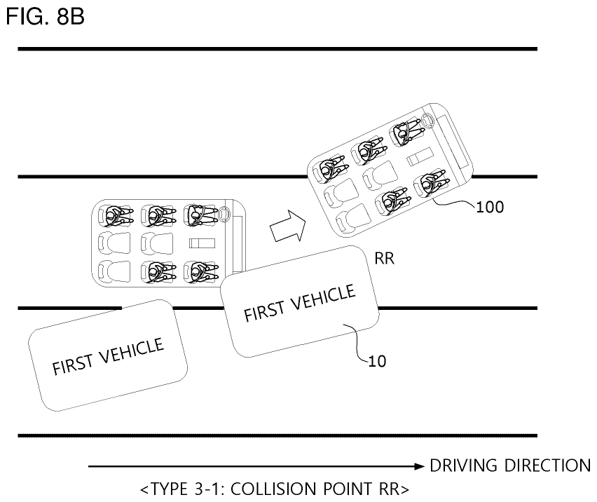

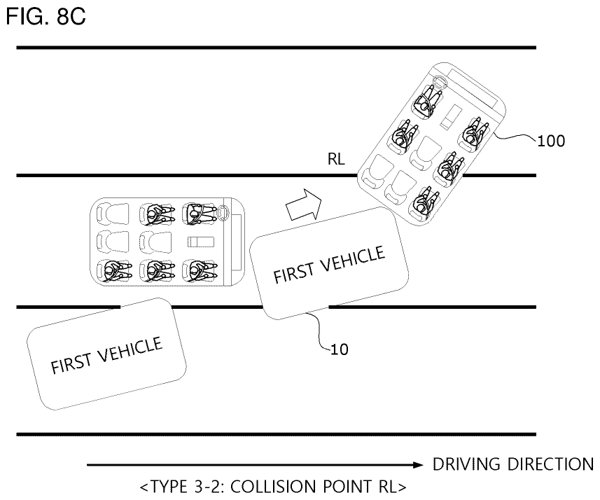

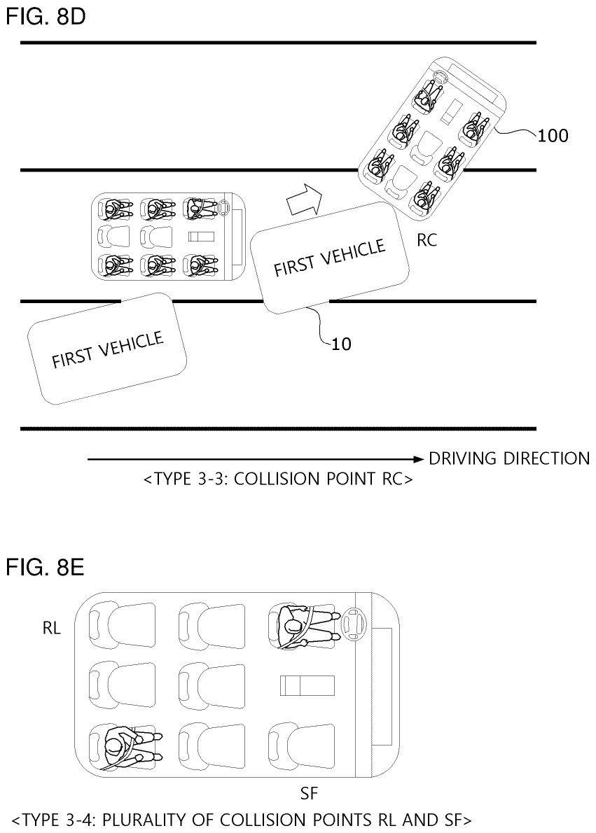

FIG. 8A is a schematic diagram illustrating collision points set for the respective subtypes of type 3.

FIG. 8A may show some among all the subtypes of type 3. Referring to FIG. 8A, type 3 may be a type in which there are passengers, but there is no side object or preceding vehicle, and the subtypes of type 3 may be distinguished depending on locations of the passengers.

Further, different collision points may be matched depending on the subtypes of type 3, in particular, depending on the seating locations of the passengers. For example, when a passenger is seated in the passenger seat, the collision point RR may be matched in the third matching table. As another example, when passengers are seated in the passenger seat and a seat on the right side in the second row, the collision point RL may be matched in the third matching table. This may mean that a point farthest from the passenger in the second row is set as the collision point.

In the case of type 3, since there is no side object or preceding vehicle, acceleration and deceleration control may be performed up to a maximum acceleration that can be calculated from the system boundary of the vehicle 100, and steering control may be performed up to a maximum steering angle that does not cause rolling. In particular, a collision point that can minimize damage may be determined based on the locations of the passengers and a lateral control condition. The control unit 193 may perform the steering control and the acceleration and deceleration control so that the vehicle 100 converges as close to this collision point as possible.

The lateral control condition may be a first priority, and when a last rear row of the vehicle 100 is vacant, or when the left or right side of the rear row is vacant, steering control is performed so that the collision occurs around a location of the vacant seat. Further, the lateral control condition may be a second priority, and when there are passengers in all seats of the rear rows or when center seats of the rear rows are vacant, steering control may be performed so that the collision occurs around the center.

FIGS. 8B, 8C, 8D, and 8E are schematic diagrams illustrating collision points set for the subtypes of type 3 and vehicle control.

In FIGS. 8B, 8C, 8D, and 8E, when the determination unit 192 predicts that the first vehicle 10 will collide with the first side of the vehicle 100, the determination unit 192 may determine that the collision type is type 3 since there are passengers and there is no side object or preceding vehicle.

Referring to FIG. 8B, the determination unit 192 may determine that the collision type is type 3-1 since locations of the passengers are the passenger seat, the right and left sides in the second row, and the left side in the third row, and may confirm the collision point RR matched with type 3-1 from the third matching table. In particular, since a passenger is located on the left side in the rear row, the point corresponding to the vacant right side of the rear row may be matched as the collision point RR. The control unit 193 may perform steering control and acceleration and deceleration control so that a collision occurs at the collision point RR.

Referring to FIG. 8C, the determination unit 192 may determine that the collision type is type 3-2 since the confirmed locations of the passengers are the passenger seat, the right and left sides in the second row, and the right side in the third row, and may confirm the collision point RL matched with type 3-2 from the third matching table. In particular, since the passenger is located on the right side in the rear row, a point corresponding to the vacant left side of the rear row may be matched with the collision point RL. The control unit 193 may perform steering control and acceleration and deceleration control so that the collision occurs at the collision point RL.

Referring to FIG. 8D, the determination unit 192 may determine that the collision type is type 3-3 since the locations of the passengers are the passenger seat, the right and left sides in the second row, and the right and left sides in the third row, and may confirm the collision point RC matched with type 3-3 from the third matching table. The control unit 193 may perform steering control and acceleration and deceleration control so that a collision occurs at the collision point RC.

Referring to FIG. 8E, the determination unit 192 may determine that the collision type is type 3-4 since the location of the passenger is the right side in the third row and confirm the collision points RL and SF matched with type 3-4 from the third matching table. In particular, two collision points may be matched with type 3-4.

When the plurality of collision points are matched, the determination unit 192 may compare an initially calculated prediction time point of the collision with the first vehicle 10 with the preset reference value to select one of the plurality of collision points. When the prediction time point of the collision with the first vehicle 10 is smaller than the reference value, in particular, when a time remaining until collision is very short and it is difficult to steer so that a collision occurs at the collision point RL within the collision prediction time, the determination unit 192 may determine that the collision point SF is the collision point. In particular, the determination unit 192 may select the collision point SF requiring steering control with a smaller angle among the plurality of collision points. The reference value may be, for example, 1 second and may be changed.

On the other hand, when the initially calculated collision prediction time point is greater than the reference value, the determination unit 192 may select the collision point RL requiring steering control with a larger steering angle among the plurality of collision points. This may be because the collision point RL has a greater collision mitigation effect than the collision point SF, and time may be given for steering control to induce a collision at the collision point RL.

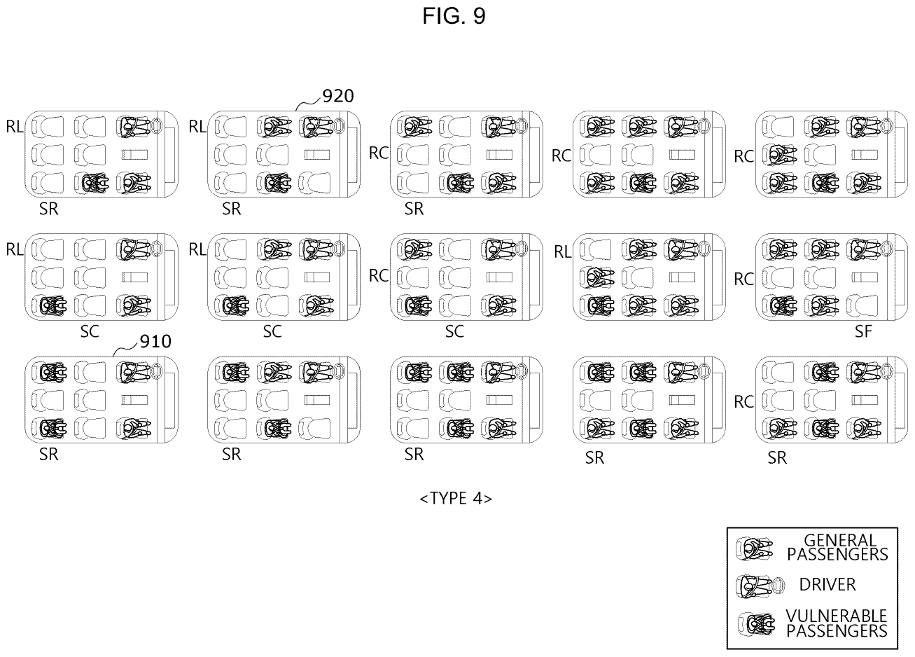

FIG. 9 is a schematic diagram illustrating collision points set for the respective subtypes of type 4.

In FIG. 9, some among all the subtypes of type 4 may be illustrated. Referring to FIG. 9, the subtypes of type 4 may be distinguished depending on locations of vulnerable passengers and general passengers. Type 4 may be a type in which a priority for the vulnerable passengers is set, and there are general passengers, side objects, and vulnerable passengers, and there is no preceding vehicle.

Further, different collision points may be matched depending on the subtypes of type 4. For example, when a general passenger is seated in the passenger seat and a vulnerable passenger is seated in a seat on the right side in a second row, the collision points SR and RL may be matched as collision points in the third matching table. In another example, when a general passenger is seated in the passenger seat and a vulnerable passenger is seated in a seat on the right side in a third row, the collision points SC and RL may be matched as collision points in the third matching table.

The control unit 193 may basically inherit a control scheme of type 2.

However, when a vulnerable passenger is seated on the first side, the collision point (or a direction in which collision damage is reduced) may be changed as an exception so that the reduction of damage to the vulnerable passenger can be prioritized. In addition, the lateral control and the longitudinal control may be performed so that the collision occurs at the changed collision point. Further, since there is a side object such as the second vehicle 20, the control unit 193 may perform steering control while maintaining the first preset safety margin distance d1 or the second preset safety margin distance d2.

Further, when vulnerable passengers are seated on both the right side and the left side of the vehicle 100, the collision point may be matched with the first side, and thus the control unit 193 may perform steering control at a bias control level to prevent damage that occurs to the vulnerable passenger due to excessive steering control. For example, in the case of type 4-1 910, the collision point SR may be set as the collision point, and the control unit 193 may perform bias control and acceleration and deceleration control so that a collision occurs at the collision point SR.

Further, in the case of type 4-2 920 in which a plurality of collision points are matched with one subtype, the control unit 193 may perform acceleration and deceleration control to induce a collision to occur on the first side (or SR) when the collision prediction time is less than or equal to the reference value. On the other hand, when the collision prediction time is greater than the reference value, the control unit 193 may perform lateral control and acceleration and deceleration control to induce a collision to occur at the collision point RL. Since this is similar to the operation described with reference to FIG. 8E, detailed description thereof is omitted.

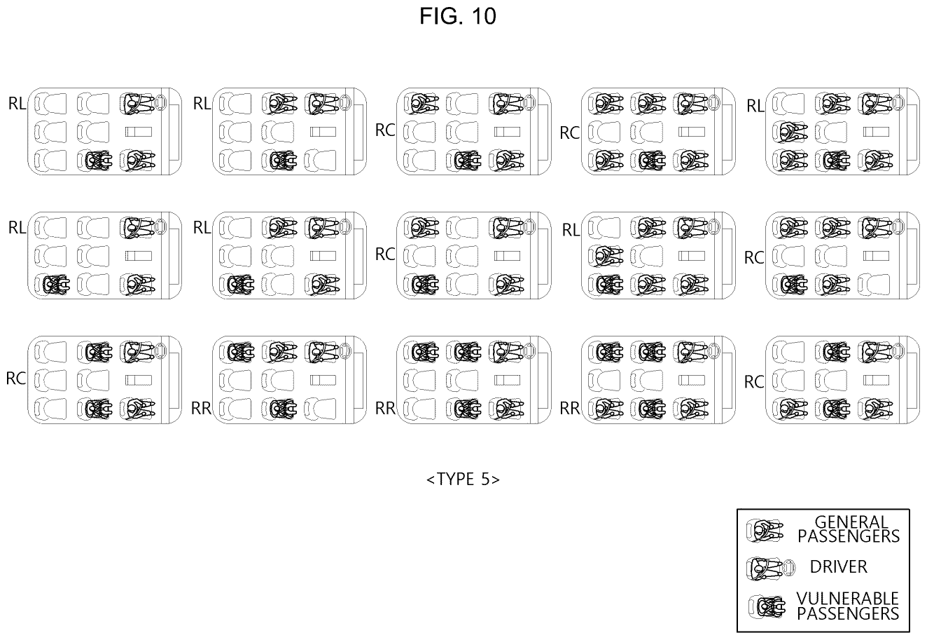

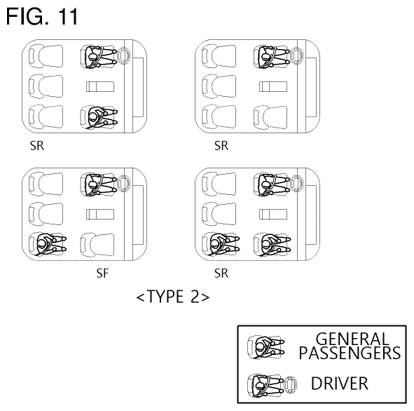

FIG. 10 is a schematic diagram illustrating collision points set for the respective subtypes of type 5.

In FIG. 10, some among all the subtypes of type 5 may be illustrated. Referring to FIG. 10, the subtypes of type 5 may be distinguished depending on locations of vulnerable passengers and general passengers. Type 5 may be a type in which a priority for the vulnerable passengers is set, there are general passengers and vulnerable passengers, and there is no side object or preceding vehicle.

Further, different collision points may be matched depending on the subtypes of type 5.

The control unit 193 may basically inherit a control scheme of type 3. However, since there is no side object or preceding vehicle, the control unit 193 may perform vehicle control up to a maximum steering angle that does not cause rolling and a maximum acceleration of the vehicle 100.

Further, when a vulnerable passenger is on the first side (or the side on which a collision is predicted), the collision point (or a direction in which collision damage is reduced) may be changed so that the damage to the vulnerable passenger can be minimized, and lateral control and longitudinal control may be performed so that the collision occurs at the changed collision point.

Meanwhile, although not shown, types 6, 7, 8, 9, and 10 may inherit types 1, 2, 3, 4, and 5, respectively, but there is a difference in that there is a preceding vehicle. Therefore, the control unit 193 may perform longitudinal control so that the vehicle accelerates up to the third preset safety margin distance set. Thus, a collision with the preceding vehicle may not occur based on the required acceleration. Considering this, in the case of a plurality of conditions (for example, a situation in which there are a preceding object and a vulnerable passenger), when sufficient acceleration to maintain the third preset safety margin distance from the preceding vehicle is not possible, a combination of the deceleration control and the steering control may be used to prioritize avoiding a collision with the preceding vehicle.

FIGS. 11, 12, 13, and 14 illustrate collision points of types 2, 3, 4, and 5 in a two-row vehicle.

Collision points of the two-row vehicle illustrated in FIGS. 11, 12, 13, and to 14 may be collision points in a state in which the center row is removed from the three-row vehicle 100 described with reference to FIGS. 7A, 7B, 8A, 8B, 8C, 8D, 8E, 9, and 10. In other words, collision points of types 2, 3, 4, and 5 of the two-row vehicle may be substantially the same as the collision points of types 2, 3, 4, and 5 of the three-row vehicle 100 described with reference to FIGS. 7A, 7B, 8A, 8B, 8C, 8D, 8E, 9, and 10. Thus, detailed description thereof is omitted.

Further, although not illustrated, collision points of a four-row vehicle may also be substantially the same as the collision points of the three-row vehicle 100.

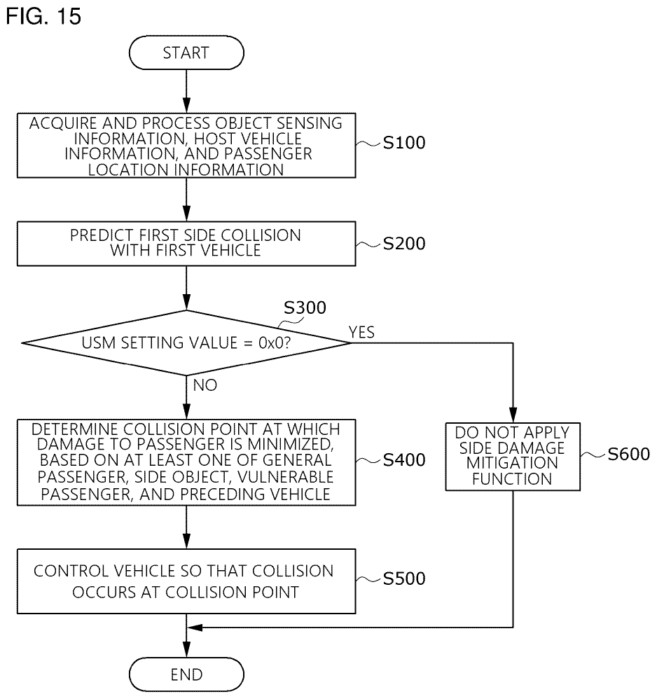

FIG. 15 is a schematic flowchart illustrating a method of controlling the vehicle 100 capable of autonomous driving according to an embodiment of the present disclosure.

Referring to FIG. 15, the vehicle 100 may process the object sensing information acquired from the object sensing unit 160, the host vehicle information acquired from the driving information detection unit 170, and the passenger location information acquired from the passenger sensing unit 180 into a form that can be processed by the processor 190 (S100).

The vehicle 100 may predict a collision with a nearby vehicle while driving. For example, when a collision is predicted to occur on the first side with the first vehicle 10 driving on the right side of the vehicle 100 (S200), the vehicle 100 may confirm the USM setting value (S300). In operation S300, the vehicle 100 may store an initially calculated collision prediction time point (or collision prediction time). Further, when the plurality of collision points are matched with one collision type, the vehicle 100 may use the initially calculated collision prediction time point and the preset reference value to select one of the plurality of collision points.

When the side damage mitigation function is set as a result of confirming the USM setting value (No in S300), the vehicle 100 may determine a collision point at which damage to the passenger is minimized based on the presence or absence of at least one of a general passenger, a side object located on the second side of the vehicle 100, a vulnerable passenger, and/or a preceding vehicle (S400).

When the collision point is determined, the vehicle 100 may perform at least one of lateral control and/or longitudinal control of the vehicle 100 so that a collision with the first vehicle 10 occurs at the collision point (S500).

In operation S500, at least one of lateral control and/or longitudinal control may be performed using, for example, the collision reference information. The collision reference information may include at least one of a location of the determined collision point, the presence or absence of a passenger, a seating location of the passenger, the presence or absence of a side object, the presence or absence of a preceding vehicle, a preset safety margin distance between the side object and the vehicle, and/or a preset safety margin distance between a preceding vehicle and the vehicle.

Further, in operation S500, when there is a side object, at least one of the lateral control and/or the longitudinal control of the vehicle 100 may be performed based on the preset first or second preset safety margin distance in order to prevent a collision between the side object and the vehicle 100, for example. In particular, the vehicle 100 may perform the lateral control or longitudinal control so that the first or second preset safety margin distance may be maintained.

Further, in operation S500, for example, when there is a preceding vehicle, at least one of the lateral control and/or the longitudinal control of the vehicle 100 may be performed based on the third preset safety margin distance for preventing a collision between the preceding vehicle and the vehicle 100, for example.

On the other hand, when the side damage mitigation function is not set in operation S300 (Yes in S300), the vehicle 100 does not apply the side damage mitigation function (S600). In particular, the vehicle 100 does not perform driving to minimize damage to passengers.

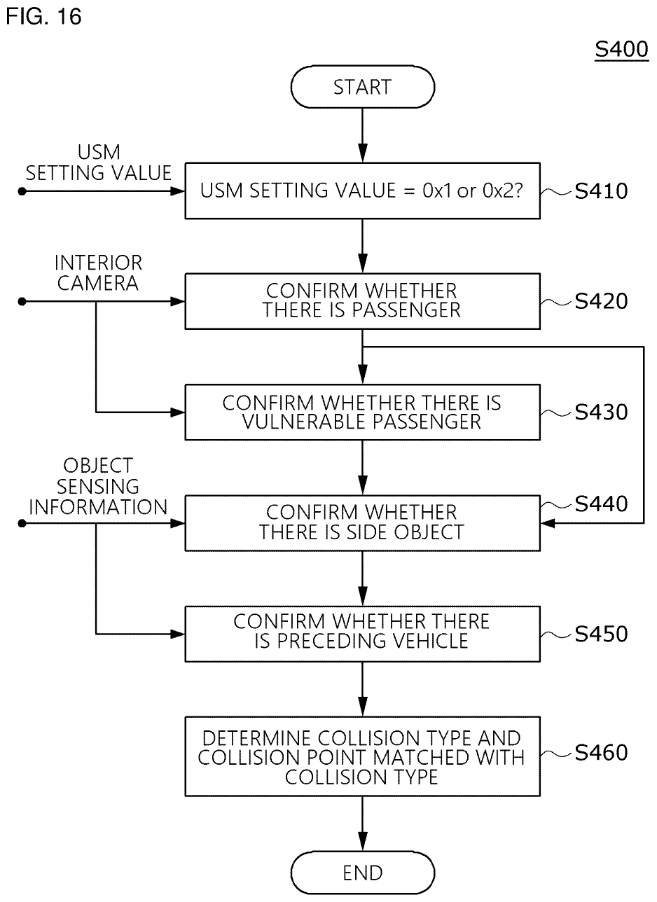

FIG. 16 is a schematic flowchart illustrating operation S400 illustrated in FIG. 15 in detail.

Referring to FIG. 16, when the USM setting value confirmed in operation S300 is 0x 1 or 0x2 (S410), the vehicle 100 may determine that the side damage mitigation function is set.

The vehicle 100 may confirm whether a passenger is located in the vehicle 100 based on the passenger location information or an interior image captured by the interior camera (S420). One or more interior cameras may be installed inside of the vehicle 100 configured to recognize passengers on board the vehicle 100 and distinguish whether the passengers are general passengers or vulnerable passengers.

Further, when the priority for the vulnerable passenger is set, the vehicle 100 may confirm whether the vulnerable passenger is located in the vehicle 100 based on the passenger location information or the interior image (S430). Using the interior camera in operation S430 may be an example, and the driver of the vehicle 100 may manually designate the seat in which the vulnerable passenger is seated.

Further, the vehicle 100 may confirm whether a side object is located on the second side based on the object sensing information (S440).

Further, the vehicle 100 may confirm whether a preceding vehicle is driving in front of the vehicle 100 based on the object sensing information (S450).

The vehicle 100 may determine the collision type based on the information confirmed in operations S410, S420, S430, S440, and S450, and confirm the collision point matched with the determined collision type from the third matching table (S460). In operation S460, the confirmed collision type may be one of types 1, 2, 3, 4, 5, 6, 7, 8, 9, and 10. Further, when there are a plurality of confirmed collision points, the vehicle 100 may compare the initially calculated prediction time point of the collision with the first vehicle 10 with the preset reference value to select one of the plurality of collision points.

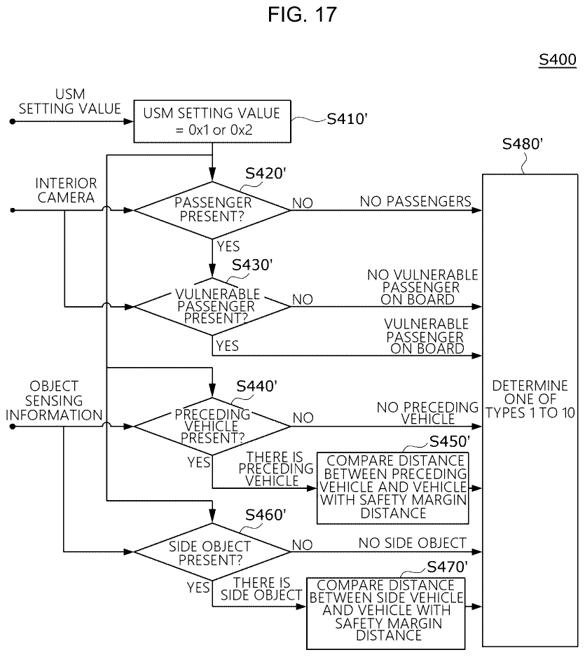

FIG. 17 is a schematic flowchart illustrating operation S400 illustrated in FIG. 15 in more detail.

Referring to FIG. 17, when the USM setting value confirmed in operation S300 is 0x 1 or 0x2 (S410′), the vehicle 100 may determine that the side damage mitigation function is set.

The vehicle 100 may confirm whether a passenger is located in the vehicle 100 based on location information of the passenger or an interior image captured by the interior camera (S420′). When there is no passenger, the vehicle 100 may generate a flag indicating that there is no passenger.

Further, when a priority for a vulnerable passenger is set, the vehicle 100 may confirm whether the vulnerable passenger is located in the vehicle 100 based on the passenger location information or the interior image (S430′). When there is no vulnerable passenger, the vehicle 100 may generate a flag indicating that there is no vulnerable passenger and there is a general passenger. Further, when there is a vulnerable passenger, the vehicle 100 may generate a flag indicating that the vulnerable passenger is on board.

Further, the vehicle 100 may confirm whether a preceding vehicle is driving based on the object sensing information (S440′). When there is no preceding vehicle, the vehicle 100 may generate a flag indicating that there is no preceding vehicle.

When there is a preceding vehicle, the vehicle 100 may compare a distance between the preceding vehicle and the vehicle 100 with the third preset safety margin distance, and generate a flag indicating that there is a preceding vehicle (S450′).

Further, the vehicle 100 may confirm whether a side object is located on a second side based on the object sensing information (S460′). When there is no side object, the vehicle 100 may generate a flag indicating that there is no side object. When there is a side object, the vehicle 100 may compare a distance between the side object and the vehicle 100 with the first or second preset safety margin distance, and generate a flag indicating that there is a side object (S470′).

The vehicle 100 may determine a collision type based on the information confirmed or calculated in operations S410′, S420′, S430′, S440′, S450′, S460′ and to S470′, and confirm the collision point matched with the determined collision type from the third matching table (S480′). In operation S480′, the determined collision type may be one of types 1, 2, 3, 4, 5, 6, 7, 8, 9, and 10. Further, when there are a plurality of confirmed collision points, the vehicle 100 may compare the initially calculated prediction time point of the collision with the first vehicle 10 with the preset reference value to select one of the plurality of collision points.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe embodiments of the present disclosure, and the matters described in the various embodiments may be applied independently or in combination of two or more.

In addition, various embodiments of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

According to the present disclosure, it is possible to provide passengers with active and proactive side safety measures, rather than conventional passive driving safety, by executing a side collision mitigation strategy before a side collision of the vehicle.

Additionally, according to the present disclosure, it is possible to enhance the safety of vulnerable passengers or rear-seat passengers and improve marketability by addressing the needs of customers concerned with the safety of rear-seat passengers through a side collision mitigation strategy that considers vulnerable passengers or rear-seat passengers.

While embodiments have been shown and described above, it will be apparent to those having ordinary skill in the art that modifications and variations could be made without departing from the scope of the present disclosure as defined by the appended claims.

What is claimed is:

1. A vehicle that allows autonomous driving comprising:
at least one processor; and
at least one memory configured to store at least one program executed by the processor,
wherein the at least one processor is configured to control driving of the vehicle such that a collision occurs at a collision point at which side damage to the vehicle is reduced, based on a seating location of a passenger and an adjacent object present in predetermined distance from the vehicle in a first side collision in which a collision on a first side of the vehicle with a first vehicle is predicted and a side damage mitigation setting is active.

2. The vehicle of claim 1, wherein the at least one processor includes:
a determination unit configured to determine a collision point at which passenger damage is minimized, based on at least one of the seating location of the passenger or the adjacent object when the first side collision with the first vehicle is predicted; and
a control unit configured to perform lateral control or longitudinal control of the vehicle to prevent a collision with the adjacent object and to cause the collision with the first vehicle at the collision point based on that the adjacent object is present.

3. The vehicle of claim 2, wherein the adjacent object includes a preceding vehicle that drives in front of the vehicle, a following vehicle that drives behind the vehicle, and an adjacent object that possibly collides with a second side of the vehicle.

4. The vehicle of claim 3,
wherein the determination unit is configured to transmit a preset safety margin distance to the control unit to prevent a collision between the side object and the vehicle when there is the adjacent object, and
wherein the control unit performs lateral control or longitudinal control of the vehicle based on the preset safety margin distance.

5. The vehicle of claim 4, wherein the preset safety margin distance when the passenger is seated on the second side of the vehicle is equal to or greater than the preset safety margin distance when the passenger is not seated on the second side.

6. The vehicle of claim 3,
wherein the determination unit is configured to transmit to the control unit, a preset safety margin distance for preventing a collision between the preceding vehicle and the vehicle when there is a preceding vehicle, and
wherein the control unit is configured to perform lateral control or longitudinal control of the vehicle based on the present safety margin distance.

7. The vehicle of claim 3, wherein the determination unit is configured to compare an initially calculated prediction time point of the collision with the first vehicle with a preset reference value to select one of a plurality of collision points determined based on at least one of the seating location of the passenger or the adjacent object when there are a plurality of collision points.

8. The vehicle of claim 7, wherein the determination unit is configured to select the collision point requiring less steering control among the plurality of collision points when the prediction time point of the collision with the first vehicle is within the preset reference value.

9. The vehicle of claim 7, wherein the determination unit is configured to select the collision point requiring more steering control among the plurality of collision points when the prediction time point of the collision with the first vehicle is greater than the preset reference value.

10. The vehicle of claim 3,
wherein the determination unit is configured to transmit collision reference information including at least one of a location of the determined collision point, the presence or absence of a passenger, a seating location of the passenger, the presence or absence of a side object, the presence or absence of a preceding vehicle, a safety margin distance between the side object and the vehicle, or a safety margin distance between the preceding vehicle and the vehicle to the control unit, and
wherein the control unit is configured to perform lateral control or longitudinal control of the vehicle based on the collision reference information.

11. The vehicle of claim 1, wherein the at least one processor is configured to perform at least one of lateral control or longitudinal control of the vehicle so that the damage to at least one of a vulnerable passenger or a general passenger is minimized based on whether a priority for the vulnerable passenger is set.

12. The vehicle of claim 3,
wherein the determination unit is configured to determine the collision point using a matching table in which one or more collision points are matched with each of a plurality of conditions, and
wherein the plurality of types include:
a first condition in which there is no passenger, side object, or preceding vehicle;
a second condition in which there are a passenger and side object, and there is no preceding vehicle;
a third condition in which there is a passenger, and there is no side object or preceding vehicle;
a fourth condition in which there are a passenger and a side object, there is no preceding vehicle, a priority for a vulnerable passenger in a side damage mitigation setting is active, and one or more vulnerable passengers are included among passengers;
a fifth condition in which there is a passenger, there is no side object or preceding vehicle, a priority for a vulnerable passenger is set, and one or more vulnerable passengers are included among passengers; and
sixth, seventh, eighth, ninth, and tenth conditions in which the presence of a preceding vehicle is added to the first, second, third, fourth, and fifth conditions, respectively.

13. A method of controlling a vehicle that allows autonomous driving including at least one processor and at least one memory configured to store at least one program executed by the at least one processor, the method comprising:
predicting a first side collision, which occurs when a first vehicle collides with a first side of the vehicle; and
controlling driving of the vehicle so that a collision occurs at a collision point at which side damage to the vehicle is minimized, based on a seating location of a passenger and an adjacent object present in predetermined distance from the vehicle in a case where a side damage mitigation setting is active.

14. The method of claim 13, wherein the controlling of the driving of the vehicle includes:
determining a collision point at which passenger damage is minimized, based on at least one of the seating location of the passenger or the adjacent object when the first side collision with the first vehicle is predicted; and
performing lateral control or longitudinal control of the vehicle so that the collision with the first vehicle occurs at the collision point while preventing a collision with the adjacent object when there is an adjacent object.

15. The method of claim 14, wherein the adjacent object includes a preceding vehicle that drives in front of the vehicle, a following vehicle that drives behind the vehicle, and a side object that possibly collides with a second side of the vehicle.

16. The method of claim 15, wherein the determining of the collision point includes:
confirming a preset safety margin distance to prevent a collision between the side object and the vehicle when there is the side object, and
wherein the performing of the lateral control or longitudinal control includes performing lateral control or longitudinal control of the vehicle based on the safety margin distance.

17. The method of claim 16, wherein a safety margin distance when the passenger is seated on the second side of the vehicle is equal to or greater than a safety margin distance when the passenger is not seated on the second side.

18. The method of claim 15,
wherein the determining of the collision point includes confirming a preset safety margin distance for preventing a collision between the preceding vehicle and the vehicle when there is a preceding vehicle, and
wherein the performing of the lateral control or longitudinal control includes performing lateral control or longitudinal control of the vehicle based on the preset safety margin distance.

19. The method of claim 15, wherein the determining of the collision point includes:
comparing an initially calculated prediction time point of the collision with the first vehicle with a preset reference value to select one of a plurality of collision points determined based on at least one of the seating location of the passenger or the adjacent object when there are a plurality of collision points.

20. The method of claim 19, wherein the determining of the collision point includes:
selecting the collision point requiring less steering control among the plurality of collision points when the prediction time point of the collision with the first vehicle is within the preset reference value.

21. The method of claim 19, wherein the determining of the collision point includes:
selecting the collision point requiring more steering control among the plurality of collision points when the prediction time point of the collision with the first vehicle is greater than the preset reference value.

22. The method of claim 15,
wherein the determining of the collision point includes generating collision reference information including at least one of a location of the determined collision point, the presence or absence of a passenger, a seating location of the passenger, the presence or absence of a side object, the presence or absence of the preceding vehicle, a preset safety margin distance between the side object and the vehicle, or a preset safety margin distance between the preceding vehicle and the vehicle, and
wherein the performing of the lateral control or longitudinal control includes performing lateral control or longitudinal control of the vehicle based on the collision reference information.

23. The method of claim 13, wherein the controlling of the driving includes:
performing at least one of lateral control or longitudinal control of the vehicle to minimize damage to at least one of a vulnerable passenger or a general passenger based on whether a priority for the vulnerable passenger is set.
